(19) United States
(12) Patent Application Publication
(10) Pub. No.: US 2001/0011235 A1
(43) Pub. Date: Aug. 2, 2001

(54) Apparatus for realizing personal shops in an electronic commerce business

(75) Inventors: Ki Yeol Kim, Seoul (KR); Sang Keun Lee, Seoul (KR); Byoung Il Lee, Seoul (KR)

Correspondence Address: William R. Evans, Ladas & Parry, 26 West 61 Street, New York, NY, 10023, US

(73) Assignee: E-NET CO., LTD.

(21) Appl. No.: 09/767,643

(22) Filed: Jan. 23, 2001

(30) Foreign Application Priority Data
Jan. 29, 2000 (KR) 2000-4452
Jun. 1, 2000 (KR) 2000-30179
Jun. 20, 2000 (KR) 2000-33880
Jul. 25, 2000 (KR) 2000-42842
Aug. 8, 2000 (KR) 2000-45937

(51) Int. Cl. G06F 17/60

(52) U.S. Cl. 705/26; 705/10

(57) ABSTRACT

The present invention relates to an apparatus for realizing personal shops in electronic commerce business. It is an object of the present invention to provide an apparatus for realizing personal shops in an electronic commerce business, which enables users to use shopping malls easily and conveniently by presenting contents screens fit for the member specialties by members and recommending goods suitable for the purchase pattern of the users.

Further according to the present invention, the apparatus for realizing personal shops in electronic commerce business comprises foods management unit for managing goods information; a web server for providing a member registration web page to connected users, receiving users information from the users upon the member registration if the users are initiated to a membership, provides shopping malls if the users who are registered as members are logged-in, generating data from all materials during the use of the shopping malls by providing the shopping malls if the user who are registered as members, receiving goods data from the goods management unit by using analyzed customers tendency data if the users are logged-in again, and realizing and providing a unique personal shop screen to each user; a members management unit for databasing the users information from the web server and the itemized materials inputted during the use of the shopping malls with the users logged-in; and a customers information analysis unit for providing customers information, goods information, order and delivery information, customers navigation information, and so on from the members management unit, systematically processing the information, and providing to the web server the processed information of goods purchase forecast values by customers, goods interest degrees by customers, goods purchase degrees by customers, and so on.

### BACKGROUND OF THE INVENTION

1. Field of the Invention

The present invention relates to an electronic commerce business, and more particularly to an apparatus for realizing personal shops in an electronic commerce business.

2. Reference to Related Patents Applications

U.S. Pat. No. 6,101,483 Personal shopping system portable terminal

U.S. Pat. No. 6,070,149 Virtual sales personnel

U.S. Pat. No. 6,014,634 System and method for providing shopping aids and incentives to customers through a computer network

U.S. Pat. No. 6,006,251 Service providing system for providing services suitable to an end user request based on characteristics of a request, attributes of a service and operating conditions of a processor

U.S. Pat. No. 5,987,440 Personal information security and exchange tool

3. Description of Related Arts

The internet, as the aggregate body of computers and computer communication networks connecting the computers, refers to a system of enabling information accumulated in the computers to be shared. Such internet, as a worldwide communication network, has an advantage in that anyone can connect to it anywhere in the world for use. Together with the development of such internet, the electronic commerce(EC) business is being rapidly developed, and the developments of a variety of contents are progressing.

Such contents are mostly operated on a membership basis and many shopping malls are operated on a membership basis for incessantly attracting members.

As stated above, the personal information of the members and the operation states of members' shopping malls are grasped in the contents operated on a membership basis according to the internet technology developments and the contents development efforts to be utilized for members managements. That is, attempts for the customized services are made for respective members based on such information.

However, the customized services provided in currently operating general contents, by using members information inputted upon the receptions of the members or searching the number of visit times, are only to provide information in accordance with it. Therefore, there exists a problem in that contents individually customized by inputting requirement items users wish in advance are not provided or services of presenting reasonable goods to users and the like by grasping users' goods purchase patterns are not provided, as an advanced fashion.

Further, there exists a problem in that, in internet shopping malls in which numerous kinds of goods exist, the time and efforts for users to invest for goods purchase are taken as a matter of course and there is no presentation of any methods for saving the users the time and efforts.

### SUMMARY OF THE INVENTION

The present invention has been devised to solve the above problems, so it is an object of the present invention to provide an apparatus for realizing personal shops in an electronic commerce business, which enables users to use shopping malls easily and conveniently by presenting contents screens fit for the member specialties by members.

Further, it is another object of the present invention to provide an apparatus for analyzing information which collects all customers' activities possible in web servers and grasps customers' tendencies to the utmost through estimation processes, thereby being re-used in the web servers.

Further, it is still another object of the present invention to provide a web page dynamic transfer system which can provide different pages to respective users according to activation information by times automatically set by the system at connection timings in case that the users connect to certain web pages.

Furthermore, it is an object of the present invention to provide a web page dynamic transfer system which provides web pages fit to users' tendencies according to user information automatically set by the system at the time a user connects to a certain web site or inputted by a user.

Still furthermore, it is an object of the present invention to provide an electronic commerce business system having a function for reserving purchase-potential goods by respective users into shopping carts used when various kinds of goods are purchased through the electronic commerce business, an agency function for inputting goods into a shopping cart in electronic commerce business sites according to the requests of the users, and an intelligent shopping cart function for promoting sales and use convenience by providing a function of recommending certain goods according to the purchase pattern of users.

The present invention comprises foods management unit for managing goods information; a web server for providing a member registration web page to connected users, receiving users information from the users upon the member registration if the users are initiated to a membership, provides shopping malls if the users who are registered as members are logged-in, generating data from all materials during the use of the shopping malls by providing the shopping malls if the user who are registered as members, receiving goods data from the goods management unit by using analyzed customers tendency data if the users are logged-in again, and realizing and providing a unique personal shop screen to each user; a members management unit for databasing the users information from the web server and the itemized materials inputted during the use of the shopping malls with the users logged-in; and a customers information analysis unit for providing customers information, goods information, order and delivery information, customers navigation information, and so on from the members management unit, systematically processing the information, and providing to the web server the processed information of goods purchase forecast values by customers, goods interest degrees by customers, goods purchase degrees by customers, and so on.

Further, present invention comprises client units for requesting users to input certain information to servicing dynamically changing sites to the users in the dynamic web page-changing sites, or establishing it in a system itself, and outputting on the screens web pages received through a communication network according to the dynamically changing site services; a web server having information on plural sites differently designed in corresponding to the same web sites and activation information for activating one site information of plural site information, and, in case that the users connect to the sites by using the client units, extracting the activation information by using the information on the connection times and users, and transferring the sites corresponding to the activation information; a dynamic site producing unit for producing site path information to be provided to the users by searching sites information built in a database, and outputting to the client units web pages manufactured by a site-structuring template unit according to the produced site path information; a database unit for storing at least one or more site information in which times information to be activated is included; and a site-structuring template unit structured by respective sites, and for manufacturing web pages corresponding to certain sites according to information inputted from the dynamic site producing unit and transferring them to the client units.

Furthermore, the present invention comprises a communication network for performing data communications between undefined individuals connected through communication lines; plural client units having communication environments for connections to the communication network, and for displaying on screens plural goods information data inputted from external upon using an electronic commerce business, and outputting to the external key signals of selecting goods the users who identify the plural goods information data inputted from the external wish to purchase or reserve; and a web server for outputting to the corresponding client units the retained goods information data according to the communication connections of the plural users of the client units, classifying the corresponding goods information into the purchase and reservations and recording them at the same time with outputting to the corresponding client units the goods information data to be recorded on the intelligent shopping cart window if purchase or reservation key signals are inputted by the corresponding users of the client units, analyzing and databasing purchase tendencies through the purchase and reservation data of the users of the client units, recording the corresponding goods information in the intelligent shopping cart windows of the corresponding users if the users of the client units choose the purchase goods through different communication units, providing to the intelligent shopping cart windows of the corresponding users different goods information related to the goods that the corresponding users of the client units choose, and storing the goods information stored in the intelligent shopping cart windows of the corresponding users.

### BRIEF DESCRIPTION OF THE DRAWINGS

The above objects and other advantages of the present invention will become more apparent by describing in detail a preferred embodiment thereof with reference to the attached drawings, in which:

FIG. 1 is a block diagram for showing a information communication system according to an embodiment of the present invention;

FIG. 2 is a flow chart for showing a method for realizing personal shops in an electronic commerce business according to an embodiment of the present invention;

FIG. 3 is a block diagram for showing in detail a customers information analysis unit of FIG. 1;

FIG. 4 is a flow chart for showing a method for analyzing customers information using a customers information analysis unit;

FIG. 5 is a view for explaining a web page dynamic transfer system according to an embodiment of the present invention;

FIG. 6 is a view for explaining a site management system for setting dynamically transferring site information and managing respective site information schedules;

FIG. 7 is an operation flow chart for explaining a method for operating a web page dynamic transfer system according to an embodiment of the present invention;

FIG. 8 is a view for schematically showing a structure of an electronic commerce business system having an intelligent shopping cart according to an embodiment of the present invention;

FIG. 9 is a block diagram for showing a web server structure of FIG. 8;

FIG. 10 is an illustrative view for showing an example of an intelligent shopping cart displayed on a corresponding client personal computer(PC); and

FIG. 11 to FIG. 15 are flow charts for showing in detail the flows of the electronic commerce business method having the intelligent shopping cart according to an embodiment of the present invention.

### DETAILED DESCRIPTION OF THE PREFERRED EMBODIMENTS

Hereinafter, a preferred embodiment of the present invention will be described in detail with reference to the accompanying drawings.

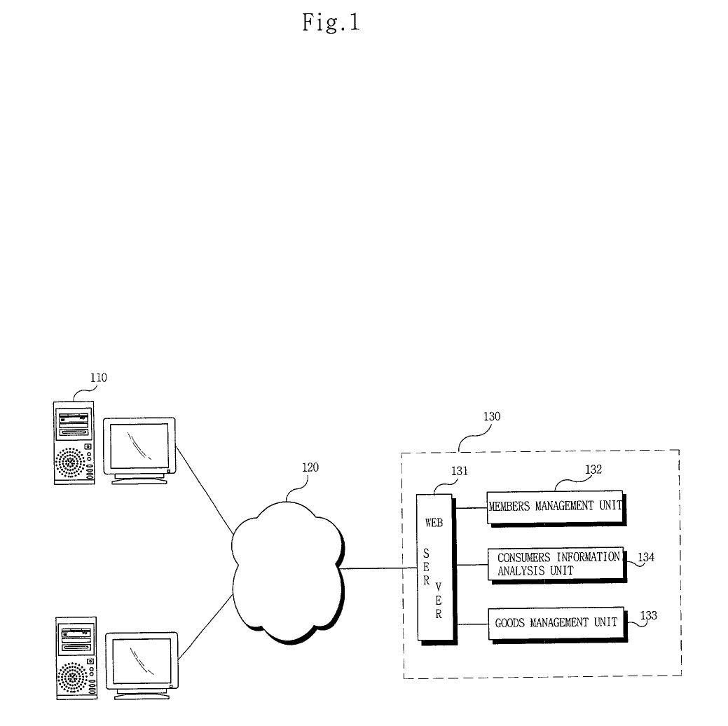

FIG. 1 is a block diagram for showing a information communication system according to an embodiment of the present invention.

As shown in FIG. 1, the information communication system according to an embodiment of the present invention includes a user terminal 110, a network such as the internet 120, and a service-providing system 130.

At this time, the service-providing system 130 has a web server 131, a member management unit 132 for managing members, a goods management unit 133 for managing the goods information, and a customers information analysis unit 134.

Here, the customers information analysis unit 134 receives customers information, goods information, orders, and delivery information, customers navigation information, and so on, and systematically processes the information, provides processed information of goods purchase forecast value by customers, goods interest degree by customers, goods purchase degree by customers, and so on to the web server 131, to thereby give more diverse services to customers. Needless to say, in here, the unit 134 receives customers information, goods information, orders, delivery information, customers navigation information, and so on, which are collected from the members management unit 132 and provides processed information by schematically processing the information, but, in its structure, can receive customers information, goods information, orders, delivery information, customers navigation information, and so on and provide the information by schematic processing by directly connecting to the web server 131.

A method for realizing a personal shop according to an embodiment of the present invention in an information communication system having the above structure will be described in brief as blow.

That is, a user is connected to the web server 131 of the service-providing system 130 through the network 120 such as the internet by using a user terminal 110.

The user connected to the web server 131 of the service-providing system 130 is requested to get a membership, and user information inputted from the user upon getting a membership is stored in a database of the members management unit 132 for managements. At this time, all materials while the user who gets a membership(hereinafter, referred to as a ‘member’ in brief) uses a shopping mall through the logging-in, that is, the information of what fields of contents the user has visited, what goods information the user has searched, or what goods the user has directly purchased, and so on is stored in a database in the members management unit 132 for management.

Further, information on user' interest fields such as news, stocks, sports, entertainments, and the like is received from the user and then stored in the database in the members management unit 132.

Furthermore, information on contents and goods that the user frequently visits is directly received from the user as well and then stored in the database in the members management unit 132.

After this, when the user is logged-in again to visit the shopping mall, the web server 131 transfers an ID of the connected user to the customers information analysis unit 134 and requests a tendency analysis with respect to the connected user. Next, the customers information analysis unit 134 which collects user information corresponding to the transferred user ID from the members management unit 132 and stores it analyzes the customer' tendency and outputs tendency data of the customer to the web server 131.

The web server 131 provides unique personal shop-realized screens to respective users by using tendency analysis data with respect to connected users.

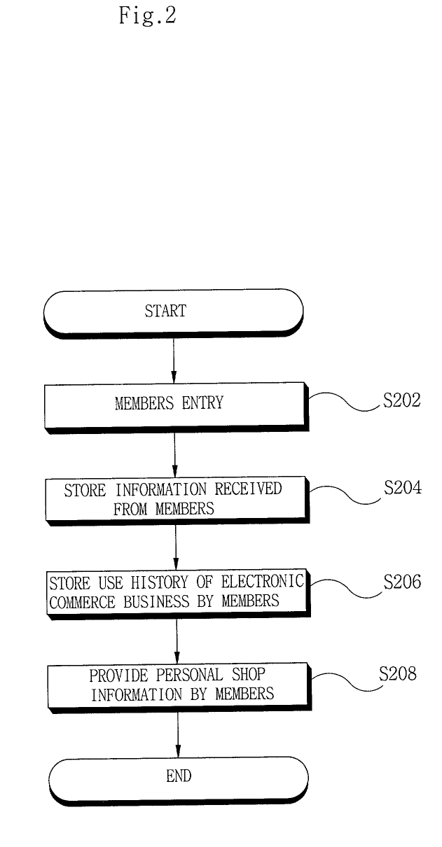

FIG. 2 is a flow chart for showing a method for realizing personal shops in an electronic commerce business according to an embodiment of the present invention.

A user connects to the web server 131 of the service-providing system 130 through the network 120 such as the internet and becomes a member by using the user terminal 110(S202).

At the time, the member is requested to select his/her interest fields such as sports, entertainments, music, movie news, and so on, in addition to general personal information, and the information is stored in the members management unit 132(S204). Further, a request is made to list goods he/she wishes to purchase and goods of interest, and the list is stored in the members management unit 132.

After receiving the above basic items from members, all outcomes obtained from the members's use of an electronic commerce business, such as information on pages users have viewed, the kinds of goods the users the users have wanted to know in detail, purchased goods, and so on are checked member by member, stored in the members management unit 132, and managed(S206).

After that, in case that the members are logged-in again, the web server 131 requests the customers' tendency analysis to the customers information analysis unit 134 and provides customized information necessary to respective members.

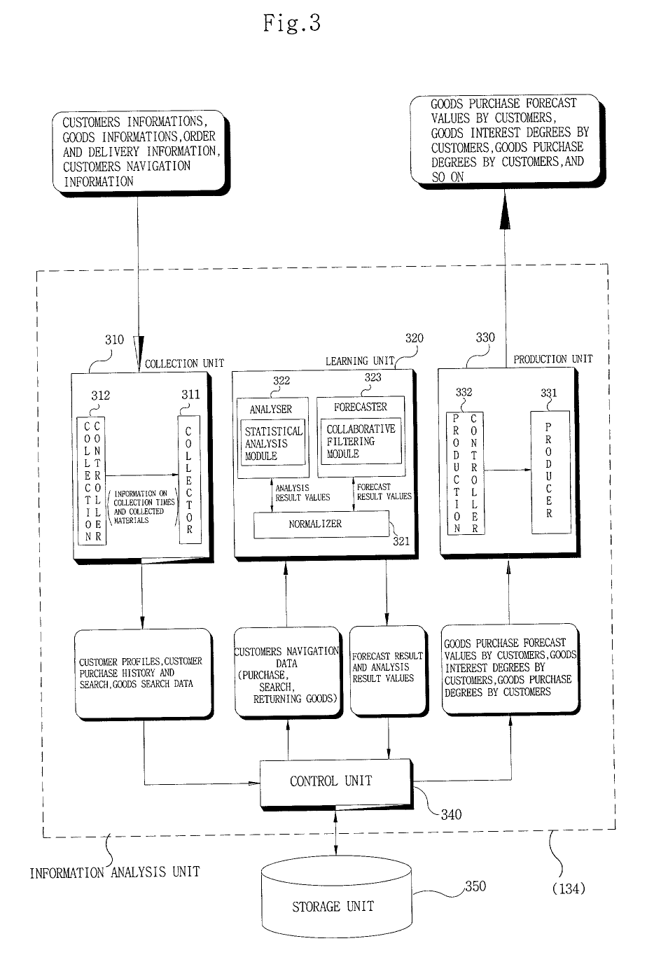

FIG. 3 is a block diagram for showing in detail a customers information analysis unit of FIG. 1.

Referring to FIG. 3, the customers information analysis unit includes a web server 131 or a collection unit 310 for collecting diverse information one customers obtained from the members management unit 132, a learning unit 320 for calculating out forecast result values and analysis result values by analyzing and processing the information obtained from the collection unit 310, production unit 330 for sending to respective fields goods recommendation services provided from shopping malls and data learned in the learning unit 320 for supporting marketing activities(CTI, Target Mailing), a storage unit 350 for managing data transferred from the collection unit and the learning unit 320, and a control unit 340 for controlling transferring data among the respective units(collection unit, learning unit, production unit, and storage unit).

First, a detailed description on the collection unit 310 will be made as follows.

That is, the collection unit 310 plays a role of taking basic information on customers and goods, customers navigation information, or the like to the storage unit 350 from a shopping mall.

That is, in order to realize the one-to-one marketing in the electronic shopping mall, since reasonable forecasts(What goods would a member purchase?) can be made by integrally collecting and analyzing diverse navigation of customers, the collection unit 310 plays a role of integrally collecting and classifying all the navigation of goods searches, web page navigation, purchases, claims, and so on, for customers. Further, the collection unit 310 leaves navigation information by customers hardly obtained from an existing web log in a separate log, enabling page connection times, the number of connection times, moving paths, and so on, of customers to be obtained. In addition, the collection unit 310 plays a role of obtaining information on the number of purchase times, purchase amounts, refund amounts, the number of refund times, search terms, and so on, y users and storing it in the storage unit 350.

For this, the collection unit 310 is divided to a collector(collection agent(module)) 311 and a collection control unit 312 in which the collector(collection agent) (hereinafter, simply referred to as “collector”) collects data under the control of a collection control unit 312 according to set collection rules. The separation into the collector 311 and the collection control unit 312 enables more expandable collection policy to be established.

The operational principle of the collection unit 310 is the same as below. That is, if registering the respective collectors 311 to a setting file, particular collectors at set times defined by a scheduler operate according to set collection rules(that is, the collection unit 310 consists of plural collectors 311), a collector 311 collects navigation data of a particular customer under the control of the collection control unit 312 according to its own collection rule and stores it in the storage unit(Analyzer DB) 350.

The improved items for the collection unit 310 compared to related arts are the same as below. That is, the collection unit 310 can collect all the possible customers navigation in the electronic shopping malls as well as facilitate the future analysis for the customers data by systematically integrating and classifying the collections. Further, part of conventional products require shopping malls to be restructured to collect customers navigation, whereas the collection unit 310 of the customers information analysis unit 134 according to the present invention is constructed in a structure to be capable of collecting all the customers navigation information without modifying shopping malls which are objects for collections or with least modifications of them.

Next, a detailed descriptions on the learning unit 320 will be made as below.

That is, the learning unit 320 analyzes all activities(searches, purchases, navigation) of users in a statistical method from raw data collected by the collection unit 310 and uses statistical methods, collaborative filtering methods, or the like with respect to activity histories of users(the number of goods purchase times, the number of goods click times, time stayed on goods pages, and the like, of users), to thereby forecast future activities of the users and then recommend goods of a high purchase possibility or goods of much interest.

For this, the learning unit 320 consists of a normalizer(Normalization(module)) 321, an analyzer 322, and a forecaster 323.

Activity data of customers such as the time of goods purchase times, the number of goods click times, time stayed on goods pages, and so on, of customers are obtained from shopping malls(sites), and the activity data of customers are used to obtain learning consequences such as goods interest degrees of customers, purchase degrees, and so on. Since all the activity data has different meanings, it can not be learned together. So the normalizer (Normalization(module)) 321 sets a score range in order for each activity data to be converted into a certain score and plays a role of scoring the values of the activity data according to the set range. That is, the normalizer 321 brings data for a recent certain time period out of the activity data of customers, determines scores in a certain range for every activity data by using statistical methods such as standard normal distribution method and so on, and scores newly stored activity data every day, to enable the analyzer 322 and the forecaster 323 to use the generalized values.

A statistical analysis module in the analyzer obtains certain values with respect to a relationship(purchase degree, interest degree, and so on) between periods and subjects (customers and goods, customers and sites, customers and shops, and so on) through the statistical analysis method about the values calculated by the normalizer 321.

The collaborative filtering module in the forecaster 323 calculates expected activities of customers by using users' activity(raw data), a result calculated by the normalizer 321 (normalization), a result calculated by the analyzer 322, and so on. A method used for the forecaster 323 forecasts expected activities of potential users who do not act in electronic commerce business sites by using similarity calculation, neighboring group extraction, extracted neighboring groups with collaborative filtering.

The similarity calculation is to calculate a relationship between customers for extracting customers having similar tendencies by using the result the customers have acted so far. The calculation is to extract the correlation between customers by using the activity data of individual customers, so the statistical analysis method is used.

The neighboring group extraction is to extract customers of a similar tendency by using the similarity degree calculation result. The neighboring groups are determined with the similarity degree values between customers obtained by the similarity degree calculation, and, in the methods for determining the neighboring groups, with defining a threshold of the similarity degree values, a method for determining only the customers over the threshold as neighboring groups, a method for determining only upper 30% of the customers as neighboring groups, and so on can be chosen.

Through a method of the above collaborative filtering and so on, before customers do activities such as goods searches, navigation, purchases, and so on in electronic commerce business sites, after expected information on what activities the customers do is extracted, diverse information suitable to the customers is provided by using it.

The improved items of the learning unit 320 according to the present invention compared to the conventional arts are the same as below. That is, the existing recommendation engines recommend goods by using a statistical analysis or the collaborative filtering with only particular information, whereas the recommendation engine (the learning unit 320) of the customers information analysis unit 134 according to the present invention can be learned by using all data that can be obtained from corresponding sites. When learning by using various data, with judging the importance degree for every data, it is constructed in order for important data to have more influence on the learning result. Further, in case that the collaborative filtering is performed by using particular data, incorrect results come out due to a shortage of information to make exact recommendations impossible. In order to solve the problem, the customers information analysis unit(analyzer) 134 complements the incorrect result due to the information shortage by using activities by users(visit pages, visit times, the number of visit times) which can be obtained from sites.

Lastly, the production unit 330 will be described in detail as below.

The production unit 330, in order to support the recommendation goods data or the marketing activities(CTI, Target Mailing) for shopping malls(sites) by the production unit 331, plays a role of sending data learned by the learning unit 320 to the corresponding fields.

For this, the production unit 330 is divided into a producer (producer agent (producer module)) 331 and a production control unit 332, similarly with the collection unit 310, and the producer (producer module) (hereinafter, referred to as “producer” in brief) 331, as shown in the production control unit 332, produces production data. By dividing the producer 331 and the production control unit 332 as stated above, it comes to have a more expandable structure.

The operation principle of the production unit 330 is the same as below.

That is, the production control unit 332 produces production rules(the production rules consist of the matching rules of transferring data of the storage unit 350 of the customers information analysis unit to data of Merchant recommendation, Mail, CTI, and so on) through a service screen the customers information analysis unit 134 provides, and produces desired data with the producer 331 operated according to the production rules set at desired times by a scheduler.

At this time, the producer 331 is installed in the customers information analysis unit(“Commercial Analyzer”) 134 or in the web server(Merchant) 131 for operations.

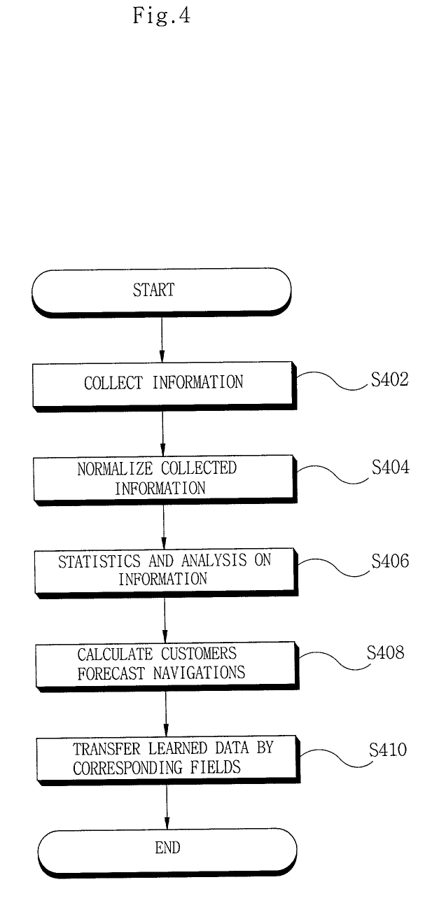

FIG. 4 is a flow chart for showing a method for analyzing customers information using the customers information analysis unit.

That is, as shown in FIG. 3, the customers information analysis unit 134 has the collection unit 310 for collecting diverse information on customers from the web server 131 or the members management unit 132, the learning unit 320 for calculating expectation result values and analysis result values by analyzing and processing information collected through the collection unit 310, the production unit 330 for sending recommendation goods data or data learned in the learning unit 320 for supporting the marketing activities(CTI, Target Mailing) to a shopping mall(the web server 131) by corresponding fields, the storage unit 350 for managing data transferred from the collection unit 310 and the learning unit 320, and the control unit 340 for controlling data moving along the respective units(collection unit, learning unit, production unit, storage unit).

As the first step, an execution process in the collection unit 310 will be described in detail as below.

The collection unit 310 plays a role of taking basic information of customers and goods and information of customers navigation and the like to the storage unit 350 from the shopping mall(the web server 131).

For this, the collection unit 310 is divided to a collector 311 and a collection control unit 312 in which the collector 311 collects data as indicated in a collection control unit 312 (S402)

That is, if registering the respective collectors 311 to a setting file, particular collectors at set times defined by a scheduler operate(that is, the collector consists of plural collection agents), a collector 311 collects navigation data of a particular customer under the control of the collection control unit 312 and stores it in the storage unit(Analyzer DB) 350.

Next, an execution process(S404 to S408) in the learning unit 320 will be described in detail as below.

That is, the learning unit 320 analyzes all activities (searches, purchases, navigation) of users in a statistical method from raw data collected by the collection unit 310 and uses statistical methods, collaborative filtering methods, or the like with respect to activity histories of users(the number of goods purchase times, the number of goods click times, time stayed on goods pages, and the like, of users), to thereby forecast future activities of the users and then recommend goods of a high purchase possibility or goods of much interest(S404 to S408).

For this, the learning unit 320 consists of a normalizer(Normalization) 321, an analyzer 322, and a forecaster 323.

Activity data of customers such as the time of goods purchase times, the number of goods click times, time stayed on goods pages, and so on, of customers are obtained from shopping malls(shtes), and the activity data of customers are used to obtain learning consequences such as goods interest degrees of customers, purchase degrees, and so on. Since all the activity data has different meanings, it can not be learned together. So the normalizer (Normalization(module)) 321 sets a score range in order for each activity data to be converted into a certain score and plays a role of scoring the values of the activity data according to the set range(S404).

A statistical analysis module in the analyzer 322 obtains certain values with respect to a relationship(purchase degree, interest degree, and so on) between periods and subjects (customers and goods, customers and sites, customers and shops, and so on) through the statistical analysis method about the values calculated by the normalizer 321(S406).

The collaborative filtering module in the forecaster 323 calculates expected activities of customers and provides information suitable for customers by using users' activity(raw data), a result calculated by the normalizer 321 (normalization), a result calculated by the analyzer 322, and so on(S408).

Lastly, an execution process in the production unit 330 will be described in detail as below.

The production unit 330, in order to support the recommendation goods data or the marketing activities(CTI, Target Mailing) for shopping malls(sites) by the production unit 331, plays a role of sending data learned by the learning unit 320 to the corresponding fields(S410).

For this, the production unit 330 is divided into a producer 331 and a production control unit 332, similarly with the collection unit 310, and the producer 331, as shown in the production control unit 332, produces production data.

That is, the production control unit 332 produces production rules(the production rules consist of the matching rules of transferring data of the storage unit 350 of the customers information analysis unit to data of Merchant recommendation, Mail, CTI, and so on) through a service screen the customers information analysis unit 134 provides, and produces desired data with the producer 331 operated according to the production rules set at desired times by a scheduler.

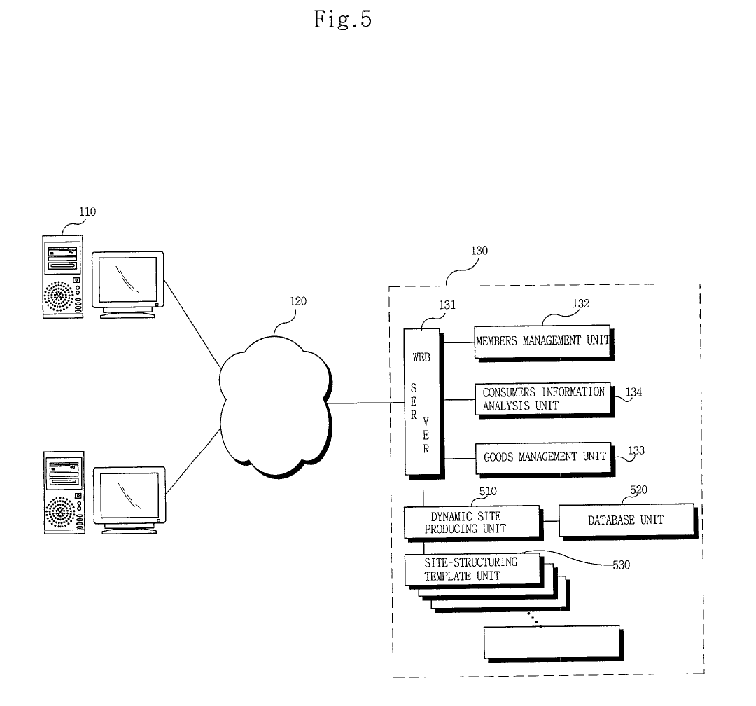

FIG. 5 is a view for explaining a web page dynamic transfer system according to an embodiment of the present invention.

As shown in FIG. 5, the communication network 120 includes the internet and the like, in case that undefined plural client computers 110 and the web server 131 are in communication connections, by using activation information on communication connection times and users tendency information according to users information inputs, services for providing differently manufactured sites to the users can be performed.

The client computers 110 receives through the communication network web pages provided from the web server 131 according to users communication connection timing or users information and displays it on the screens.

The web server 131 has activation information for activating plural site information differently designed to each other in accordance with the same web sites and one site information of the plural site information, and, in case that users connect to the web site, a corresponding site of the plural sites is transferred by using the connection timing activation information.

Further, the web server 131, if users connected to it is initiated into a member, stores users information inputted from the users upon being members in a database of the members management unit 132 for managements, and stores all materials while the user who gets a membership(hereinafter, referred to as a ‘member’ in brief) uses a shopping mall through the logging-in, that is, the information of what fields of contents the user has visited, what goods information the user has searched, and what goods the user has directly purchased, and so on in a database of the members management unit 132 for managements. After this, when the user is logged-in again to visit the shopping mall, the web server 131 transfers an ID of the connected user to the customers information analysis unit 134, requests a tendency analysis with respect to the connected user, and provides a specialized site to the member by using the customers tendency data.

Here, the detailed block diagram of the customers information analysis unit 134 is the same as FIG. 3 and the descriptions on functions thereof are the same as stated above.

In the meantime, a dynamic site producing unit 510 searches sites information from a database unit 520 to produce path information of the sites to be provided to the users, and outputs to the client computers 110 web pages manufactured by a site-structuring(the same as site-building) template unit 530 according to the produced sites path information.

The database unit 520 stores at least one or more sites information including schedule information to be activated.

The site-building template unit 530 is constructed by respective sites, manufactures web pages for certain sites produced from the dynamic site producing unit 510, and transfers them to the client computers 110.

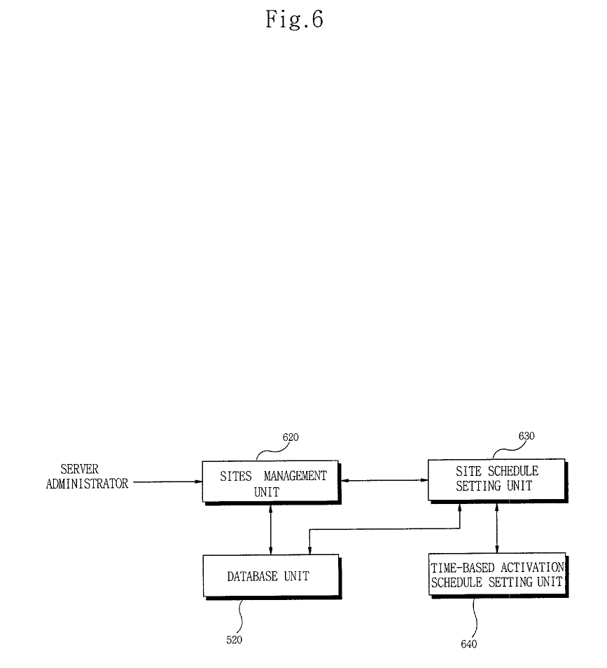

Further, as stated above, dynamically changing site information is established in order for diverse sites to be provided according to the communication connection timings of the client computers 110, and the sites management system for managing schedules on information of respective sites is done in an administrator site and will be described as below with reference to FIG. 6.

The database unit 520 shown in FIG. 6 is the same as the database unit 520 of FIG. 5.

A site schedule setting unit 630 sets schedules for determining times to be activated with respect to respective sites built by the site-structuring template unit 530 which are an constituent of FIG. 5.

The above times mean month, day, and time, and the information that such times are set is stored in the database unit 520.

A time-based activation schedule setting unit 640 analyzes schedule information set in the above site schedule setting unit 630 and sets the building of sites to be activated at the present time.

The sites management unit 620 registers at least one or more site structure to the database 520, or manages the site structure by applying modifications and deletions with respect to the sites structures stored in the database 520. At this time, the sites information stored in the database unit 520 is stored together with path information in which site structures are placed.

That is, for the present invention, the concrete descriptions as stated above are restrained only to that the web server 131 checks the times users have connected by using a dynamic shopping mall web page-changing system realized in the administrator site, provides sites activated at the times to the client computers 110, so that the users receive services from different sites according to the times when the users are connected, but the present invention can realize, by grasping users' tendencies with the use of users information inputted from the users, the sites set according to the tendencies in use of the method stated above.

Operations of the dynamic web page-changing system in use of the present invention will be described in more detail with reference to the accompanying drawings.

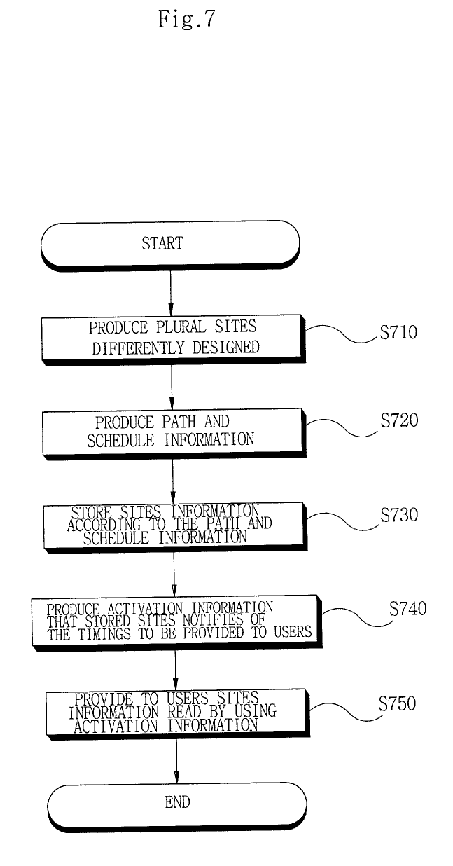

FIG. 7 is an operation flow chart for explaining a method for operating a web page dynamic transfer system according to an embodiment of the present invention.

First, a web server administrator builds plural sites with respect to respective sites including basic site, members sites, event sites, and so on, which users can be easily adapted to and which arouse users' interest(S710 and S720).

Site information built like this has path information and is stored in the database 520 by the sites management unit 620(S730).

The site information registered in the sites management unit 620 can be processed with modifications, delete, and so on, by the sites management unit 620, and schedule information to be activated is set by a site schedule setting unit 630.

A time-based activation schedule setting unit 640 sets the information of the sites to be activated at at the present time according to the schedule information of the sites set by the site schedule setting unit 630(S740).

The database unit 520 further includes users management(tendency) information.

As stated above, after the plural sites are built in a database by a web server administrator, a user performs a communication connection to the web server 131 through a web browser installed in the client computer 110.

The web server 131 provides a page in which users input log-in data through the communication network 120, or produce users information using particular technologies.

The dynamic site producing unit 510 reads sites information to be provided to users from the database unit 520 by using users information produced by the web server 131 and activation site information set by the time-based activation schedule setting unit 640, and web pages manufactured by the site-structuring template unit 530 in correspondence with corresponding sites are transferred to client computers 110 of the users(S750).

As stated above, a system can be constructed in order for the web server 131 to read different site information at every time of users' connections and to provide it to users, and as stated above, the system can be structured to classify users' tendencies by using users information that users input upon an member registration to the web server 131 and to provide differently designed sites according to the classified tendencies to the users.

Needless to say, plural sites can be manufactured in correspondence to the classified tendencies, to provide them by connection times.

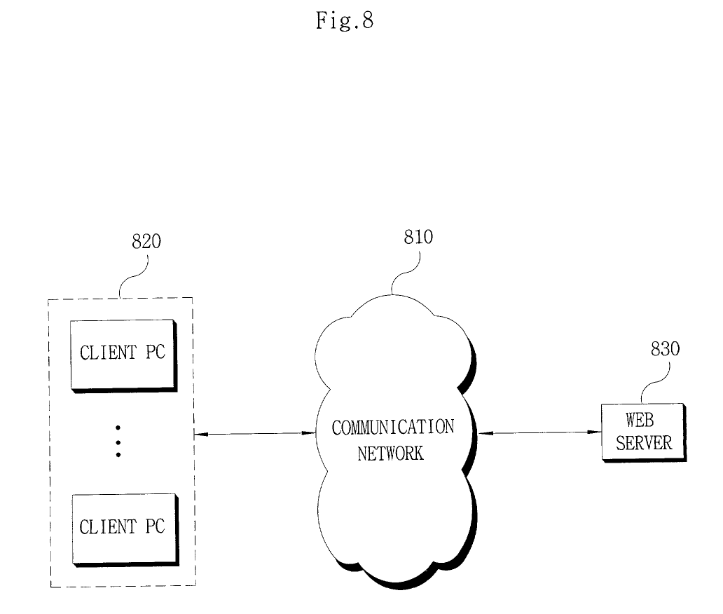

FIG. 8 is a view for schematically showing a structure of an electronic commerce business system having an intelligent shopping cart according to an embodiment of the present invention.

As shown in FIG. 8, a communication network 810 is a communication network such as the internet and the like, which connects communication lines between plural client PCs 820 and a web server 830 and then performs data communications related to electronic commerce business therebetween.

The plural client PCs 820 has built-in communication environments including web browser of enabling the connections to the communication network 810, displays on screens plural goods information data inputted from the web server 830, to be described later, upon using the electronic commerce business, and, if users who identifies plural goods information data inputted from the web server 830 select goods they wish to purchase or reserve, transfer corresponding key signals to the web server 830.

The web server 30 outputs retained goods information data to the corresponding client PCs 820 according to the communication connections of the users of the plural client PCs, and, if the key signals for purchases or reservations are inputted by the users of the corresponding client PCs 820, classifies and registers the corresponding goods information into purchases and reservations on an intelligent shopping cart window 1021 at the same time with outputting goods information data registered on the intelligent shopping cart window 1021 to the corresponding PCs 820.

Further, the web server 830 analyzes purchase tendencies through the purchase or reservation data of the users of client PCs 820 and builds them in a database, and, in case that the users of client PCs 820 request purchase goods through communication means such as telephones, mails, or the like other than computers, a server administrator registers corresponding goods information on the intelligent shopping cart windows 1021 of the corresponding users by proxy.

Further, the web server 830 extracts from retained plural goods information different goods information data related to the goods that the corresponding users of the client PCs 820 choose, provides the extracted goods information data to the intelligent shopping cart window 1021 of the corresponding users, and databases the goods information stored in the intelligent shopping cart window 1021 by corresponding users to be used when planing events such as sales and so on.

In the meantime, the web server 830 can be operated to consistently provide related goods information which is newly inputted to the corresponding users through electronic mails(E-mail) based on the purchase goods information built in the database according to the electronic commerce business of the users of the client PCs 820.

Further, it can be operated to plan gratitude events if a total purchase amount of the goods the particular users of the client PC 820 purchase in the web server 830 is more than a certain amount or to provide goods information corresponding to a shortage amount on the intelligent shopping cart window 1021 if the amount of the goods the users purchase is not reached to a certain amount.

Further, the web server 830, in case that the users of the respective client PCs 820 purchase goods in a non-member status, gives an identifier such as an IP address and the like to purchase information data recorded on the intelligent shopping cart window 1021 and then stores it temporarily, and, if the corresponding users are registered as regular members, automatically updates the temporarily stored purchase information data into the intelligent shopping cart window 1021 of the corresponding users.

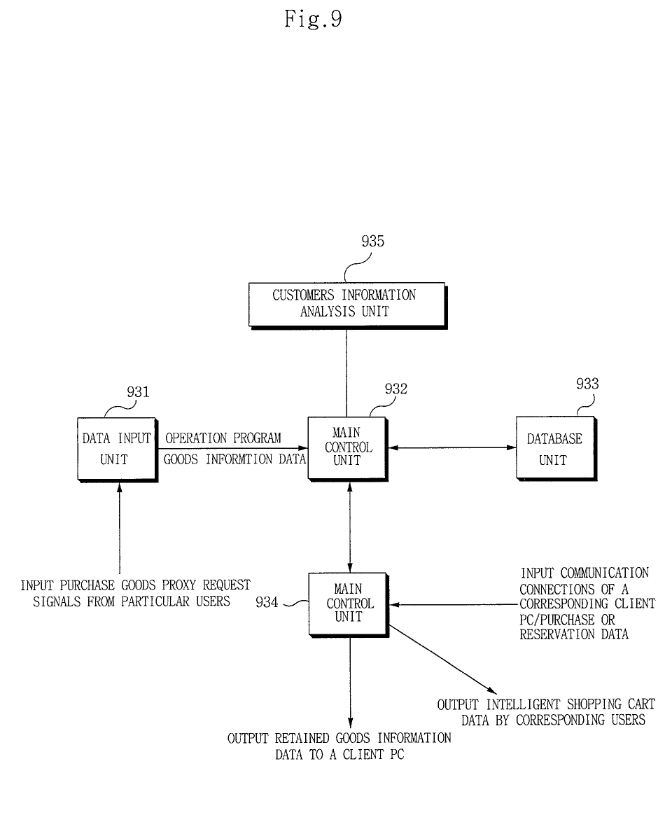

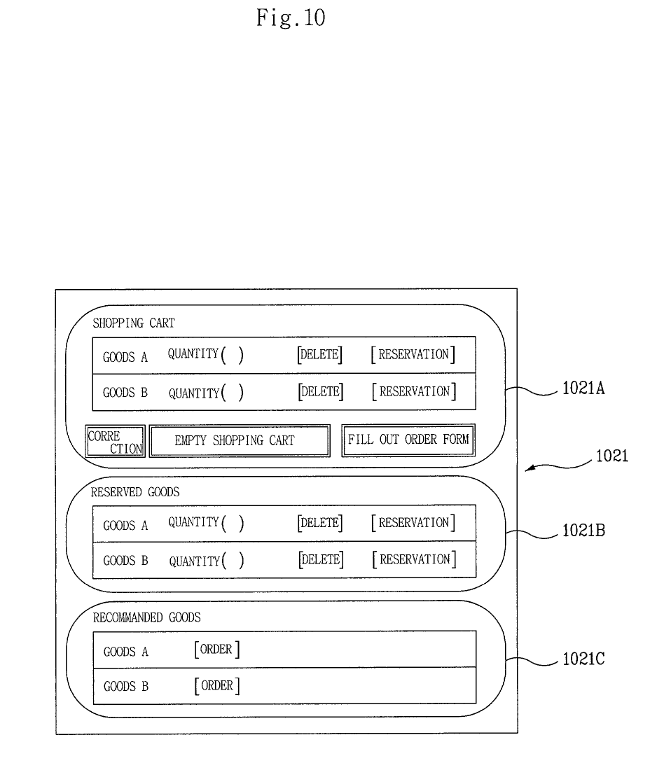

FIG. 9 is a block diagram for showing a web server structure of FIG. 8, and FIG. 10 is an illustrative view for showing an example of an intelligent shopping cart window 1021 displayed on a corresponding client PC 820.

As shown in FIG. 9 and FIG. 10, the data input unit 931 inputs operation programs related to the electronic commerce business and plural goods information to be sold to plural users of the client PCs 820 by a server administrator and outputs them to a main control unit 932 to be described later, and, if a purchase goods proxy request signal requested by a particular user is inputted, outputs the corresponding data to the main control unit 932 to perform a proxy registration of goods to be purchased.

The main control unit 932 controls to store the plural goods information data inputted through the data input unit 931 into a database unit 933 to be described later, and, if plural users of the client PCs 820 are connected, outputs the goods information data retained in the database unit 933 to the corresponding client PC 820, and, if a purchase or a reservation key signal selected after the users of the corresponding client PCs 820 identifies the goods information data is inputted, controls to record the corresponding goods information data to the intelligent shopping cart window 1021 and to output it to the corresponding client PCs 820.

Further, the main control unit 932 controls to analyze purchase tendencies by corresponding users and to store purchase tendency data analyzed through a customers information analysis unit 935 into the database unit 933, and, if the users input purchase goods proxy request signals through the data input unit 931, records corresponding goods information to the intelligent shopping cart windows 1021 of the users by proxy, controls to extract different goods information related to the goods the respective users choose to output it to the intelligent shopping cart windows 1021 of the corresponding users, and controls the storage of data recorded in the intelligent shopping cart windows 1021 of the corresponding users. Here, the detailed block diagram of the customers information analysis unit 935 is the same as FIG. 3 and has the same functions as stated above.

The database unit 933, according to the control of the main control unit 932, stores members registration data of the users of the client PCs 820, plural goods information data on sales on-line, and data recorded on the intelligent shopping cart windows 1021 by the corresponding users in accordance with the use of the electronic commerce business, and stores the purchase tendency data performed in the customers information analysis unit 935 according to the goods purchase of the corresponding users.

The communication control unit 934 outputs to the corresponding client PCs 820 the plural goods information data outputted from the main control unit 832 according to the communication connections of the plural client PCs 820, outputs to the main control unit 932 the goods purchase or reservation key signals inputted from the client PCs 820, and outputs to the corresponding client PCs 920 the intelligent shopping cart data including the goods purchase or reservation information the corresponding users of the client PCs choose, the recommendation goods information extracted according to the goods purchase or reservation, and the goods purchase information inputted according to the goods purchase proxy requests of the users.

Further, the intelligent shopping cart window 1021 has a purchase goods display unit 1021A for displaying plural goods information data selected for purchases by the users of the client PCs 820, a reservation goods display unit 1021A for displaying plural goods information data selected for reservations by the users of the client PCs 1020, and a recommendation goods display unit 1021C for displaying different goods information data related to the goods information data recorded in the purchase goods display unit 1021A out of the goods information data stored in the web server 830.

Furthermore, an order form fill-out button, a modify button, a delete button, and so on are provided for the purchase goods display unit 1021A of the intelligent shopping cart window 1021.

At this time, the plural goods information data displayed in the purchase goods display unit 1021A and the reservation goods display unit 1021B can be inputted by proxy of a server administrator according as the users of the client PCs 820 requests to the web server 830 the goods to be purchased through telephones, mails, and so on, in addition to the goods that the users of the client PCs 820 directly select through the connection to the web server 830.

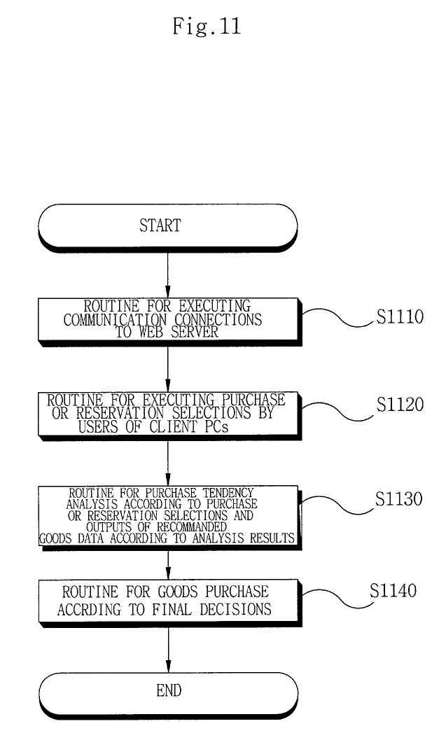

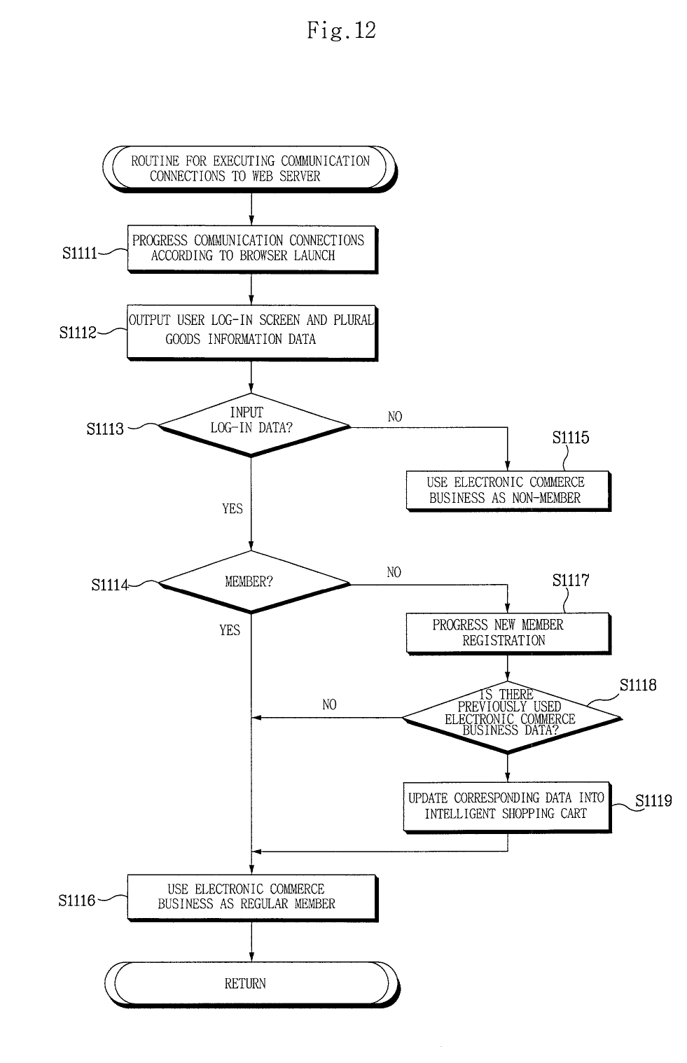

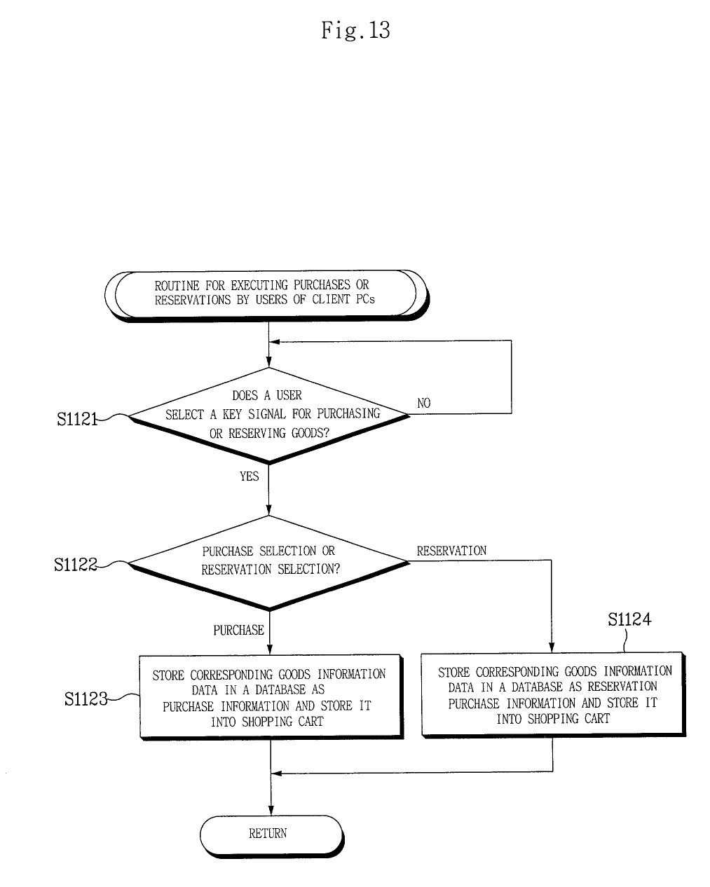

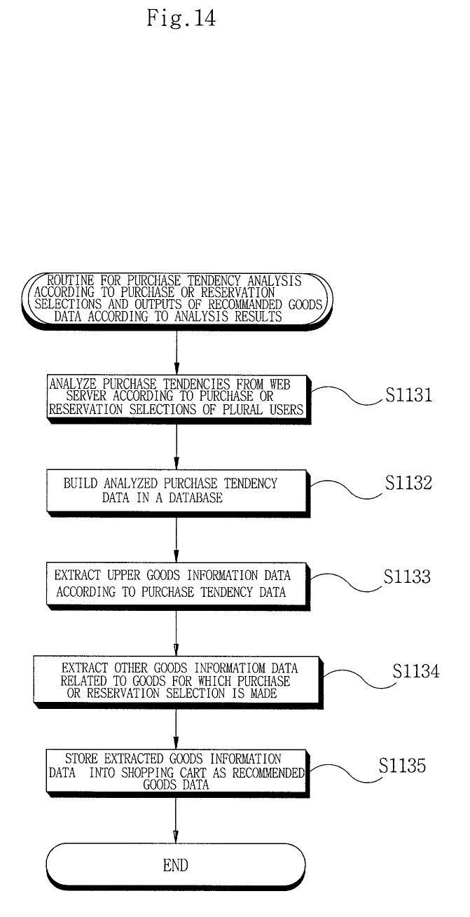

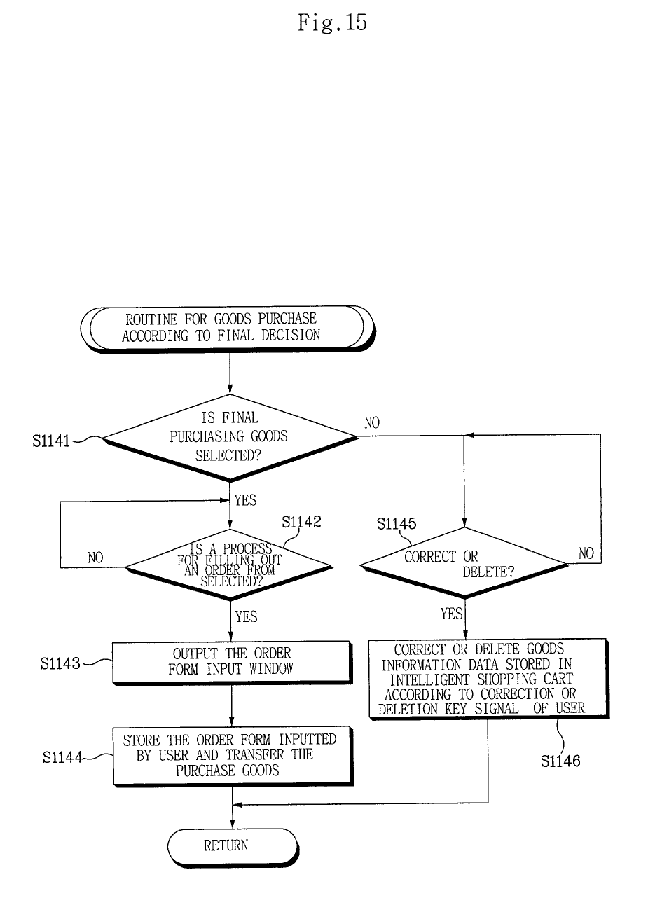

Next, operations of the electronic commerce business having the intelligent shopping cart functions according to the present invention having the above structure will be described in detail with reference to FIG. 11 to FIG. 15.

FIG. 11 to FIG. 15 are flow charts for showing in detail the flows of the electronic commerce business method having the intelligent shopping cart according to an embodiment of the present invention.

First, the users of the client PC 820 performs communication connections to the web server 830 opened in the communication network 810 for using the electronic commerce business(s1110).

That is, if each user performs the communication connection to the web server 830 by launching a browser installed in the client PC 820(S1111), the web server 830 outputs a user log-in screen and retained plural goods information data to the corresponding client PC 820(S1112), and judges whether the corresponding user of the client PC 820 inputs an ID and a password through the user log-in screen(S1113).

As a result of the judgement, if the log-in data each user inputs is received to the web server 830, the web server 830 judges whether the user is a member through the log-in data of the ID and password the user inputs(S1114).

However, as a result of the judgement in the step S1113, if the user does not input the log-in data, the web server 1130 uses the plural goods information data provided in the web server 1130 since the corresponding user is a non-member(S1115).

Further, as a result of the judgement in the step S1114, in case that the logged-in user is a regular member, the web server 830 uses the plural goods information data provided in the web server 830 since the corresponding user is the regular member(S1116), and, in case of a non-member, the web server 830 proceeds with a new member registration to store the member registration data the user inputs(S1117).

If registered as a regular member according to the new member registration as stated above,. the web server 830 judges whether there exists previously used electronic commerce business data in the state the user who performs the new member registration is a non-member(S1118), and, in case that there exists the electronic commerce business data previously used, the web server 830 updates corresponding data to the intelligent shopping cart in order for the corresponding user to confirm the goods information data previously reserved(S1119).

At this time, for the judgement of the web server 830 on whether the user who performs the new member registration has data previously used, a method for identifying it through an IP address, and so on, of the corresponding users who performs the new member registration is used, in addition to different methods other than the identification method.

as stated above, after the connections of the users of the client PCs 820 to web server 830 through the step S1110, the web server 830 verifies whether the users of the client PCs 820 who confirms the plural goods information data purchases or reservation-purchases the corresponding goods(S1120).

That is, the web server 830 judges whether the a user who confirms the plural goods information data provided to each client PC 820 selects a key signal for purchasing or reserving the goods(S1121), and, if the key signal is selected, judges whether the key signal the user of the client PC 820 inputs is for the purchase or for the purchase reservation(S1122).

As a result of the judgement, in case that the key signal for purchasing goods is inputted by a user, the web server 830 stores the corresponding goods information data in the database 833 as purchase information to be displayed on a purchase goods display part 1021A of the intelligent shopping cart window 1021 of the corresponding user(S1023), and, in case that the key signal for reservation-purchasing the goods is inputted, the web server 830 stores the corresponding goods information data in the database unit 833 as the reservation purchase information to be displayed at a reservation goods display part 1021B of the intelligent shopping cart window 1021 of the corresponding user(S1124).

Further, the web server 830 after the above step S1120 analyze purchase tendencies of the users of the client PCs 820 according to the purchases or reservation selections, and includes the recommendation goods data according to the analysis results and the recommendation goods data related to the goods the corresponding users select into the intelligent shopping cart to be thereby provided to the corresponding users of the client PCs 820(S1130).

That is, the web server 830 analyzes the purchase tendencies according to the purchases or the reservation selections of the users of the client PCs 820(S1131), and databases the purchase tendency data analyzed according to the purchases or the reservation selections of the users of the client PCs 820 to verify what kinds of goods are popular(S1132).

Furthermore, highly ranked goods information data is extracted which is popular through a database built according to the purchase tendencies of the users of the client PCs 820 who use the electronic commerce business (S1133), or different goods information data related to the corresponding goods on which the purchases or the reservation selections of the users of the client PCs 820 are made is extracted(S1134) and the extracted goods information data is stored at the recommendation goods display part 1021C of the intelligent shopping cart window 1021 as the recommendation goods data(S1135).

Lastly, the web server 830 verifies whether a goods order form is filled out for the corresponding goods according to the final decision of the user of the client PC 820 which confirms the purchase goods/reservation goods/ recommendation goods data related to the goods purchase displayed in the intelligent shopping cart window 1021, and sends the purchase goods to the corresponding user(S1140).

That is, the web server 830 judges whether the goods to be finally purchased by a user who verifies the intelligent shopping cart window 1021 displayed together with the purchase/reservation/recommendation goods information data are selected(S1141), and the filling-out of an order form is selected by the corresponding user after the purchase goods are selected(S1142).

As a result of the judgement, if the filling-out of the order form is selected by the user of the client PC 820, the web server 830 outputs an order form input window(not shown) to the corresponding client PC 820(S1143), and, if an order form of delivery information is filled out, the web server 830 stores the order form and sends the corresponding purchase goods to the user, ending the electronic commerce business(S1144).

However, in the step S1141, if the purchase goods are not selected by the corresponding user, the web server 830 judges whether the modify or the delete of the purchase goods is selected by the user(S1145), and modifies or deletes the goods information data displayed in the intelligent shopping cart window 1021 according to the modify or the delete key signal of the corresponding user(S1146).

At this time, even though the electronic commerce business is finished with the completion of the purchase goods order by the corresponding user of the client PC 820 through the above step S1140, the reservation goods information data recorded on the intelligent shopping cart window 1021 remains untouched.

In the meantime, even though not shown in the drawings, if the web server 830 receives the goods a user of the client PC 820 wishes to purchase by using phones or mails, the server administrator registers the corresponding goods information data by proxy to be displayed at the reservation goods display part 1021B of the intelligent shopping cart window 1021 of the corresponding user.

The present invention as stated above has an excellent effect in that members can enjoy shopping with more convenience and at leisure by providing information on interest fields and goods fit to the characteristics of respective members.

Further, the present invention has an excellent effect in that cumbersomeness of asking the busy modern people time and efforts for goods selections and purchases can be reduced.

Further, the present invention has an excellent effect in that all customers' activities likely to occur in the electronic shopping malls in can be collected, systematically integrated and classified, to facilitate the analysis with respect to future customers data.

Further, the present invention has an excellent effect in that it has a structure of allowing all the customers activity information to be collected without modifications or only with the least modifications of the shopping malls which is objects for the collections.

Further, the present invention has an excellent effect in that it can be learned by using all data possible to be obtained from the corresponding sites, when leaned by using various data, and the important data can have a more influence to the learning results by judging the importance degree for every data.

Further, the present invention has an excellent effect in that, in order to solve a problem that exact recommendations become impossible since incorrect results come out when information becomes short in case of performing collaborative filtering by using only particular data, it provides exact recommendation information to customers by complementing the incorrect recommendation due to the shortage of information by using the navigation(visit pages, visit times, the number of visit times) and the like which can be obtained in sites.

Further, the present invention can provide an effect as if using new sites by dynamically changing sites according to the times a user who uses the internet makes an connection at and the user information.

Further, the present invention, in case of members, has an effect in that the site to be newly constructed can be used in realizing the same site as generally called personal shop.

Further, the present invention has an effect in that new designs can be reflected in the state that the existing designs remains untouched and tests for the new designs facilitated.

Further, the present invention has an effect in that, since the planing of the various sites are realized to be simultaneously used, new site planning can be realized in the state that the existing sites in operation remain untouched.

Further, most of existing web sites adds pages related to events for the events or planning for presenting event goods is done, and, occasionally, the entire site designs are changed to the event characteristics, the present invention has an effect in that sites can be effectively operated by adding new sites without influence given to the existing sites.

Further, the electronic commerce business system having an intelligent shopping cart function, by displaying and providing goods purchase information data that the respective users select, in addition to the reservation goods data in future purchase intentions of the users and recommendation goods data provided in the electronic commerce business server in relation to the goods the users select on the shopping cart that most electronic commerce business sites employ, has an effect in that the sales promotions, the ultimate goals, of the electronic commerce business sites can be made by attracting many users who use electronic commerce business and doing aggressive marketing to many users.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. An apparatus for realizing personal shops in electronic commerce business, comprising:
foods management unit for managing goods information;
a web server for providing a member registration web page to connected users, receiving users information from the users upon the member registration if the users are initiated to a membership, provides shopping malls if the users who are registered as members are logged-in, generating data from all materials during the use of the shopping malls by providing the shopping malls if the user who are registered as members, receiving goods data from the goods management unit by using analyzed customers tendency data if the users are logged-in again, and realizing and providing a unique personal shop screen to each user;
a members management unit for databasing the users information from the web server and the itemized materials inputted during the use of the shopping malls with the users logged-in; and
a customers information analysis unit for providing customers information, goods information, order and delivery information, customers navigation information, and so on from the members management unit, systematically processing the information, and providing to the web server the processed information of goods purchase forecast values by customers, goods interest degrees by customers, goods purchase degrees by customers, and so on.

2. The apparatus as claimed in claim 1, wherein the customers information analysis unit includes:
a collection unit for collecting diverse information on the users from the web server;
a learning unit for calculating diverse forecast information on the customers through the learning of the information collected through the collecting unit in use of statistical method or methods of collaborative filtering and so on; and
a production unit for outputting to the web server the diverse forecast information calculated through the learning unit.

3. The apparatus as claimed in claim 2, wherein the collection unit includes:
a collector for collecting all customers information such as general web page navigation information, customers goods search information, purchase information, claims information, and so on, from the web server; and
a collection control unit for controlling the collector under established particular collection rules.

4. The apparatus as claimed in claim 2, wherein the learning unit includes:
a normalizer for normalizing the users activity information in the web server received from the collection unit into scores of a certain range;
an analyzer for calculating into certain values the relations between the periods and subjects through a statistical analysis method of the values normalized by the normalizer; and
a forecaster for calculating customers forecast activities by using the calculated results by the analyzer.

5. The apparatus as claimed in claim 4, wherein the method used in the forecaster provides information fit to customers by using similarity degree calculation, neighboring group extraction, and extracted neighboring group with the collaborative filtering and forecasting expected activities of potential users not in action in the electronic commerce business.

6. The apparatus as claimed in claim 3, wherein the production unit includes:
a producer for producing the information learned from the learning unit to the corresponding fields of the web server; and
a production control unit for controlling the producer under established particular production rules.

7. A dynamic web page-changing system, comprising:
client units for requesting users to input certain information to servicing dynamically changing sites to the users in the dynamic web page-changing sites, or establishing it in a system itself, and outputting on the screens web pages received through a communication network according to the dynamically changing site services;
a web server having information on plural sites differently designed in corresponding to the same web sites and activation information for activating one site information of plural site information, and, in case that the users connect to the sites by using the client units, extracting the activation information by using the information on the connection times and users, and transferring the sites corresponding to the activation information;
a dynamic site producing unit for producing site path information to be provided to the users by searching sites information built in a database, and outputting to the client units web pages manufactured by a site-structuring template unit according to the produced site path information;
a database unit for storing at least one or more site information in which times information to be activated is included; and
a site-structuring template unit structured by respective sites, and for manufacturing web pages corresponding to certain sites according to information inputted from the dynamic site producing unit and transferring them to the client units.

8. The system as claimed in claim 7, in order to provide sites dynamically changed by the main server, further comprising:
a site schedule setting unit for setting a schedule for determining times to be activated with respect to respective sites manufactured by the site-structuring template unit;
a time-based activation schedule setting unit for setting site structures to be activated at present time by analyzing the schedule information set in the site schedule setting unit; and
a site management unit for registering at least one or more site structures in the database or managing the site structure by modifying and deleting the site structure stored in the database.

9. The system as claimed in claim 7, further comprising:
a members management unit for databasing the users information from the web server and the itemized materials inputted during the use of the shopping malls with the users logged-in; and
a customers information analysis unit for providing customers information, goods information, order and delivery information, customers navigation information, and so on from the members management unit, systematically processing the information, and providing to the web server the processed information of goods purchase forecast values by customers, goods interest degrees by customers, goods purchase degrees by customers, and so on, wherein the web server provides to the respective users the web sites manufactured according to the users characteristics by using users tendency analysis data provided from the customers information analysis unit.

10. The system as claimed in claim 8, further comprising:
a members management unit for databasing the users information from the web server and the itemized materials inputted during the use of the shopping malls with the users logged-in; and
a customers information analysis unit for providing customers information, goods information, order and delivery information, customers navigation information, and so on from the members management unit, systematically processing the information, and providing to the web server the processed information of goods purchase forecast values by customers, goods interest degrees by customers, goods purchase degrees by customers, and so on, wherein the web server provides to the respective users the web sites manufactured according to the users characteristics by using users tendency analysis data provided from the customers information analysis unit.

11. An electronic commerce business system having intelligent shopping cart functions, comprising:
a communication network for performing data communications between undefined individuals connected through communication lines;
plural client units having communication environments for connections to the communication network, and for displaying on screens plural goods information data inputted from external upon using an electronic commerce business, and outputting to the external key signals of selecting goods the users who identify the plural goods information data inputted from the external wish to purchase or reserve; and
a web server for outputting to the corresponding client units the retained goods information data according to the communication connections of the plural users of the client units, classifying the corresponding goods information into the purchase and reservations and recording them at the same time with outputting to the corresponding client units the goods information data to be recorded on the intelligent shopping cart window if purchase or reservation key signals are inputted by the corresponding users of the client units, analyzing and databasing purchase tendencies through the purchase and reservation data of the users of the client units, recording the corresponding goods information in the intelligent shopping cart windows of the corresponding users if the users of the client units choose the purchase goods through different communication units, providing to the intelligent shopping cart windows of the corresponding users different goods information related to the goods that the corresponding users of the client units choose, and storing the goods information stored in the intelligent shopping cart windows of the corresponding users.

12. The system as claimed in claim 11, wherein the web server includes:
a data input unit for inputting operation programs related to the electronic commerce business and plural goods information data to be purchased to the plural client unit users, and inputting purchase goods proxy request signals requested by particular users;
a main control unit for controlling a storage of the plural goods information data inputted through the data input unit, outputting retained goods information data to the corresponding client unit if the plural client unit users are connected, if a purchase or a reservation key signal that the corresponding client unit users choose after confirming the goods information data is inputted, recording and the corresponding goods information data in the intelligent shopping cart windows and outputting them to the corresponding client units, controlling the storage of analyzed purchase tendency data, recording the corresponding goods information in the corresponding intelligent shopping cart windows if the users input the purchase goods proxy request signals through the data input unit, extracting different goods information related to the goods the respective users choose and outputting it to the intelligent shopping cart windows of the corresponding users, and controlling the storage of the data recorded in the intelligent shopping cart windows of the corresponding users;
a database for storing members registration data of the users of the client units according to a control of the main control unit, information data of plural goods on sale online, and data recorded in the intelligent shopping cart windows of the corresponding users according to the uses of the electronic commerce business, receiving and storing the purchase tendency data from the main control unit according to the goods purchases of the corresponding users; and
a communication control unit for outputting to the corresponding client units the plural goods information data outputted from the main control unit according to the communication connections of the plural client units, outputting to the main control unit the goods purchase or the goods reservation key signals inputted from the client units, and outputting to the corresponding client units the goods purchases or reservations information outputted from the main control unit and selected by the corresponding client unit users, recommendation goods information extracted according to goods purchases and reservations, and the intelligent shopping cart data including the goods purchase information inputted according to the goods purchase proxy requests of the users.

13. The electronic commerce business system as claimed in claim 11, wherein the intelligent shopping cart window includes:
a purchase goods display part for displaying the goods information data that the client unit users select for purchases;
a reservation goods display part for displaying the goods information data that the client unit users select for reservations; and
a recommendation goods display part for displaying different goods information data related to the goods information data recorded in the purchase goods display unit out of the goods information data stored in the web server.

14. The electronic commerce business system as claimed in claim 11, wherein the web server incessantly provides to the corresponding users the related goods information based on the purchase goods information built in the database according to the electronic commerce business of the client unit users.

15. The electronic commerce business system as claimed in claim 11, wherein the web server provides to the intelligent shopping cart window the goods information corresponding to an shortage amount in order for a total purchase amount of the goods the corresponding client unit users to reach a certain amount.

16. The electronic commerce business system as claimed in claim 11, wherein the web server temporarily stores the purchase information data recorded in the intelligent shopping cart window that each client unit user uses for goods purchase in a state of a non-member, and automatically updates the temporarily stored purchase information data to the intelligent shopping cart window of the corresponding user if a regular member registration is made for the corresponding user.
